(19) United States
(12) Patent Application Publication
(10) Pub. No.: US 2008/0275942 A1
(43) Pub. Date: Nov. 6, 2008

(54) User Defined Internet Jukebox Kiosks Set Top Box

(76) Inventor: Manuel Ignacio Tijerino, Hammond, LA (US)

Correspondence Address: MANUEL TIJERINO, 409 OAKLANE DRIVE, UNIT A, HAMMOND, LA, 70403, US

(21) Appl. No.: 11/744,228

(22) Filed: May 4, 2007

(51) Int. Cl. G06F 15/16; H04N 7/16

(52) U.S. Cl. 709/203; 725/2

(57) ABSTRACT

A system such as an Internet Juke Box, Kiosk, or Set Top Box connected to the network which is database driven and tied to an on line internet site where local artist and musicians can create a profile which will allow them to upload their media, being images, music and videos, and later go to an establishment that has this system and play it. The system will have the ability to expose local musicians to the masses and earn them money.

### CROSS-REFERENCE TO RELATED APPLICATIONS

Not Applicable

### STATEMENTS REGARDING FEDERALLY SPONSORED RESEARCH OR DEVELOPMENT

Not Applicable

### REFERENCE TO SEQUENTIAL LISTING, A TABLE OR A COMPUTER PROGRAM LISTING COMPACT DISK APPENDIX

Not Applicable

### BACKGROUND OF THE INVENTION

1. Technical Field and Industrial Applicability of the Invention

This invention relates to systems and methods for exposing local artist to the masses.

2. Description of the Related Art

Making music takes a lot of time, dedication and money. The people lucky enough to have a band still have to work hard at playing shows and exposing themselves in a way that will counter the heavy cost of equipment and practice room rent. Current internet jukeboxes serve media in digital format, therefore artist have to pay big bucks to get a digital record and still so few get air play. Before the invention of the internet jukebox, an artist had to know someone to get their cd's into the jukebox. Now with the great technological advances of the internet and internet jukeboxes artist still have to audition, submit, and practically beg the companies to put their music in their systems. Some companies will not even consider you unless you have an existing record deal. If your music is not mainstream you can forget about getting it played on any jukebox.

### BRIEF SUMMARY OF THE INVENTION

As a programmer, musician, and sole creator of http://www.chech1two.com I have noticed the struggle faced by many local artist and musicians in the ability of promoting their music by means of the internet jukeboxes. The present invention relates particulaly to the ability of a band, artist, and or individual musician to easily upload their media to a website that is directly linked to an internet jukebox, kiosk, and or set top box.

Jukebox systems are widely used in establishments as means of promoting well known musicians. The not so well known musicians can use this invention to promote themselves without having the clout previously needed. Typically, the musicians will upload their media to the system which will allow them to earn fees and royalties. The novelty of the invention is the power an individual will have in promoting themselves.

This invention will put an end to the current struggle local musicians face today in getting their music played in the internet jukeboxes and create better livelihoods for individual artist and bands that may have never otherwise had a chance to be heard.

### BRIEF DESCRIPTION OF THE DRAWING

The foregoing aspects and many of the attendant advantages of this invention will become more readily appreciated as the same become better understood by reference to the following detailed description, when taken in conjunction with the accompanying drawing and/or FIGURE.

FIG. 1 is a perspective view of the entire system from start to finish.

### DETAILED DESCRIPTION OF THE INVENTION

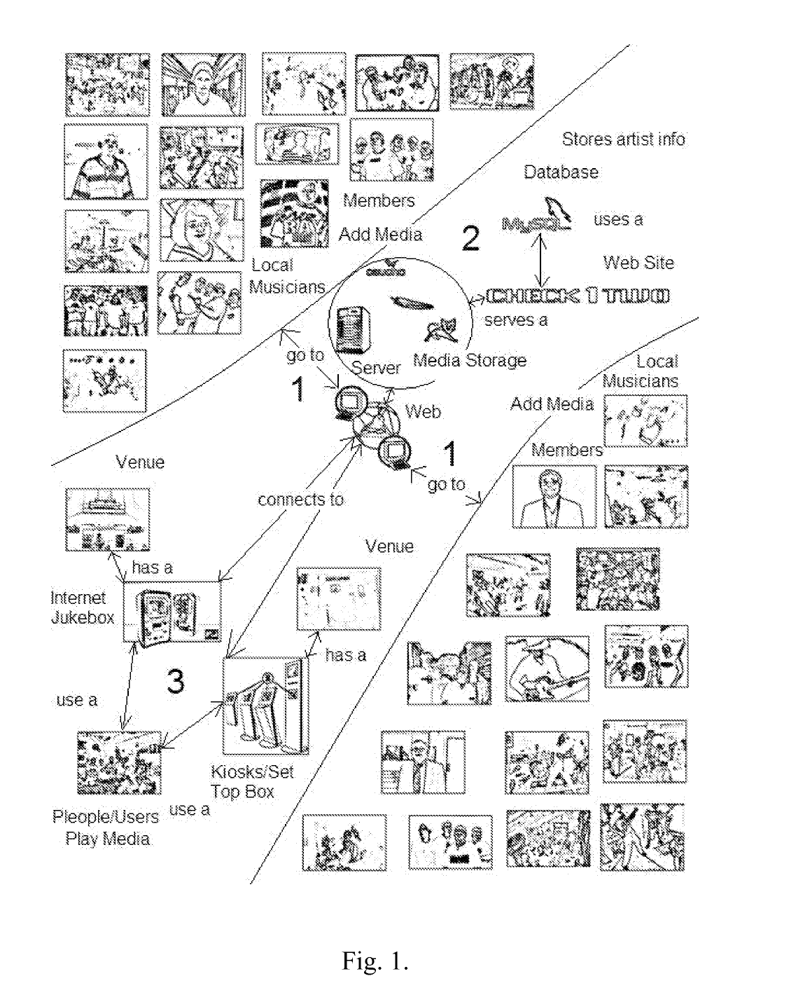

The present invention is a unique and new way to expose local artist from any state, city, or country to a world wide audience, currently not implemented by internet jukeboxes. By way of overview and with reference to FIG. 1, the system of the present invention includes the members meaning an individual musician, band, artist, etc, that add their media meaning images, music, and videos to the system, and the manner in which this media is added to the system 1. When a member gets on anything with an internet connection, such as a computer, that can upload their media they will connect to the website or user interface provided to add their media. The back end system 2 will be composed of servers, databases, and web programs that will handle storage, retrieval, and updates to the members accounts and foremost their media. The establishments that have the jukeboxes, kiosk, or set top boxes 3 will have the media available from all members in the system. This means that as soon as any member adds their media to their account it will be instantly available for playback.

What is claimed is:

1. The system will have users and members.
Members that provide the content and users that use the content.

2. From claim 1, a member's role will be to create a profile from home, work or anywhere where they have access to a computer with internet.

3. From claim 2, after a profile is created the member will be able to add his band/group/individual images to his/her profile.

4. From claim 2, the member will have the ability to upload his/her media files.

5. From claim 4, the media files may be images, music, and or videos in digital format.

6. From claim 5, as soon as the profile is created and the media and image files are uploaded the member account will receive a status of active.

7. From claim 6, upon activating the account the users media/content/profile will be available to all of the systems connected to the network as well as online for convenience.

8. From claim 1, the system will keep track of the member's media and files and play count for royalties to be paid.

9. From claim 1, and from a user's standpoint they will be using an Internet jukebox with local artist on it.

10. From claim 9, the system will also connect to existing artist just like jukeboxes do now.

11. The system will be built in an Object oriented manner which will also allow for modular expansion.

12. From claim 11, some systems will contain built in speakers and amplifiers that can be of different sizes and exchangeable, while other systems will simply connect to existing in house PA's.

13. From claim 11, some systems will contain video cards to allow connection to television sets in venues that would like that feature for video plays.

14. From claim 11, some systems will contain the ability of burning cd's on the spot for customers.

15. From claim 11, some systems will contain a bill acceptor.

16. From claim 11, some systems will be enabled to receive credit cards and debit cards as well a prepaid online accounts by account providers such as paypal.

17. From claim 11, some systems will have wired remotes for skipping tracks and volume controls while others have wireless remotes and some having both.

18. From claim 17, when a user chooses to play a file that is not stored on the hard drive the system will stream it and store it on the hard drive for future plays.

19. From claim 10, all royalties and fees will be paid to the proper content providers and or artist who created the media used, governed by their terms of use.

20. The main purpose of the system is to expose local artist to the masses without having to be signed by a major record label and having a chance to earn money while allowing more time to focus on making music, and facilitating what has been almost an impossible feat to attain today, an easy reality of tomorrow as every party involved, meaning the artist, the individual users, and the establishment, venue, bar, or club a positive experience.
